(19) United States
(12) Patent Application Publication
(10) Pub. No.: US 2002/0195491 A1
(43) Pub. Date: Dec. 26, 2002

(54) Apparatus and method for--at the time rented video media is returned--identifying damage, generating damage documentation in remote data base, and providing customer record detailing damage

(76) Inventor: Earnest B. Bunch III, Cave Creek, AZ (US)

Correspondence Address: TOD R. NISSLE, P.C., P.O. Box 55630, Phoenix, AZ, 85078, US

(21) Appl. No.: 09/892,724

(22) Filed: Jun. 26, 2001

(51) Int. Cl. G06F 17/60

(52) U.S. Cl. 235/385

(57) ABSTRACT

A method and apparatus for renting and return video media retrofits a conventional retail establishment which rents VCR tapes, DVDs, and other video media. The retrofit enables the retail establishment to determine at the time rented video media is returned whether the video is damaged. Equipment installed in the retail establishment communicates with a remote data base both to help determine if returned video media is damaged and to generate documentation of any damage which is detected.

This invention relates to apparatus and methods for renting and returning video media.

More particularly, the invention relates to a method and apparatus for identifying damage when a rented video media is returned.

In another respect, the invention relates to a method and apparatus for generating damage documentation in a remote data base when a damaged rented video media is returned.

In a further respect, the invention relates to a method and apparatus for providing a customer record detailing the damage to a returned rented video media.

BLOCKBUSTER (SM) and a variety of other retail outlets rent VCR tapes, DVDs, and other video media recorded on tape or on a compact disk. These retail outlets typically provide a return bin which enables customers to return the video media when the retail outlet is closed overnight, closed during holidays, or is otherwise temporarily closed for business. The return bin is located inside the store next to a perimeter wall of the store. A return slot extends from the return bin through the perimeter wall to the exterior of the store. A customer stands outside of the store and inserts video media in the return slot. The video media slides down the return slot, through the perimeter wall, and into the return bin. Alternatively, the customer may partially enter the store through a door and encounter a return slot formed in a perimeter wall of the store. The customer is prevented from entering the store because there is a second set of doors which are locked when the store is closed. The customer can, however, return video media by inserting it in the return slot. The video media slides through the return slot into a return bin positioned inside the store and behind and beneath the return slot.

The above described “return slot” system for returning video media is simple and has long been used by many retail establishments which rent video media. The disadvantages associated with the “return slot—storage bin” system are (1) the retail establishment has no way of confirming whether the rented video media is damaged at the time it is returned, (2) the customer has no way of proving that the rented video media is not damaged when returned, (3) the retail establishment has no way of generating at the time of return damage documentation, (4) employees may forget to empty the storage bin for a day or two, in which case the retail establishment has no way of determining when the customer returned the rented video media, (5) video media from a storage bin may inadvertently be intermixed with other video media in the retail establishment, making it difficult to determine which video media was previously rented and when the video media was returned, (6) the customer has no way of confirming when the video media was returned, and (7) the customer, since he or she often has lost the receipt received when the video media was originally rented, has no way of determining whether the video media is being returned on time or is being returned late. One upshot of the foregoing is that the customer may have to pay for a damaged tape when the customer did not cause damage to the tape. Another upshot is that it is difficult for a retail establishment to charge a customer for damage to a tape because the retail establishment has a difficult time proving that the customer damaged the tape.

Assessing damage to rental video tapes is an important issue because respect for property, especially the property of others, is now, to many people, the exception and not the rule. The “me first” rule often prevails. Some individuals view it as a game to see how much they can “get away with” in terms of damaging or taking other people's property.

Accordingly, it would be highly desirable to provide an improved apparatus and method for enabling a store to detect and document damaged video media.

Therefore, it is a principal object of the instant invention to provide an improved method and apparatus for renting and returning video media.

A further object of the invention is to provide an improved video media rental/return apparatus and method which enables damage to be detected when video media is returned during off hours.

Another object of the instant invention is to provide an improved video media rental/return apparatus and method which enables a customer at the time he or she returns video media to determine immediately whether the video media is damaged.

Yet a further object of the invention is to provide an improved video media rental/return method and apparatus which will only accept video media that is not damaged.

Still another object of the invention is to provide an improved video media rental/return method and apparatus which generates, at the time a customer returns rented video media, documentation which confirms the video media is not damaged, the date the video media was returned, and the customer's identity.

These and other, further and more specific objects and advantages of the invention will be apparent to those skilled in the art from the following detailed description thereof, taken in conjunction with the drawings, in which:

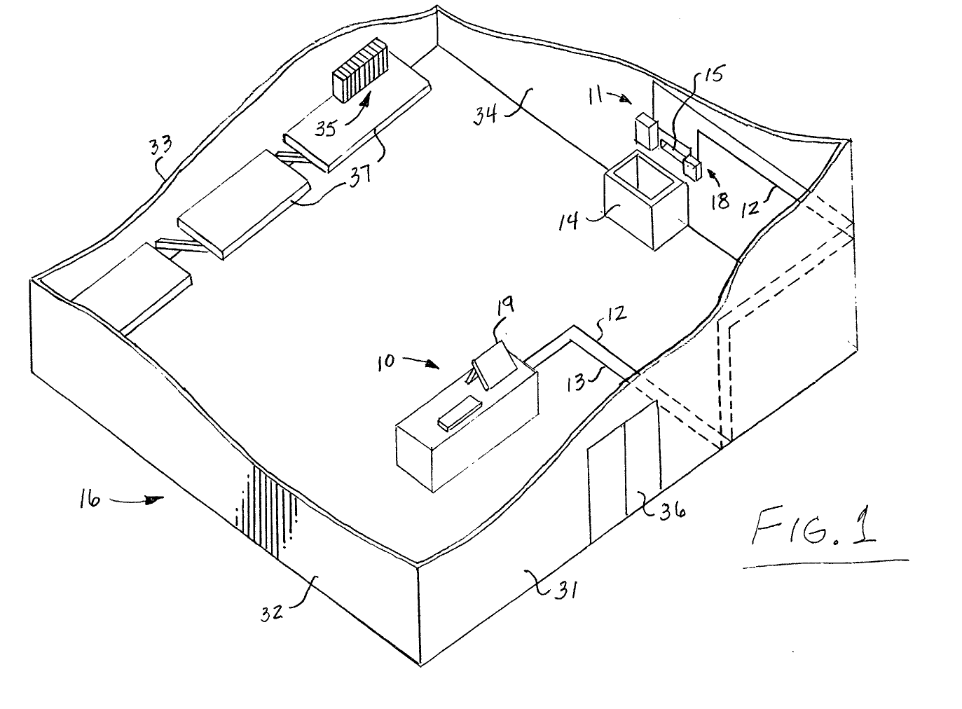

FIG. 1 is a perspective view illustrating a store structure equipped in accordance with the principles of the invention to detect damaged video media when the video media is returned during off hours;

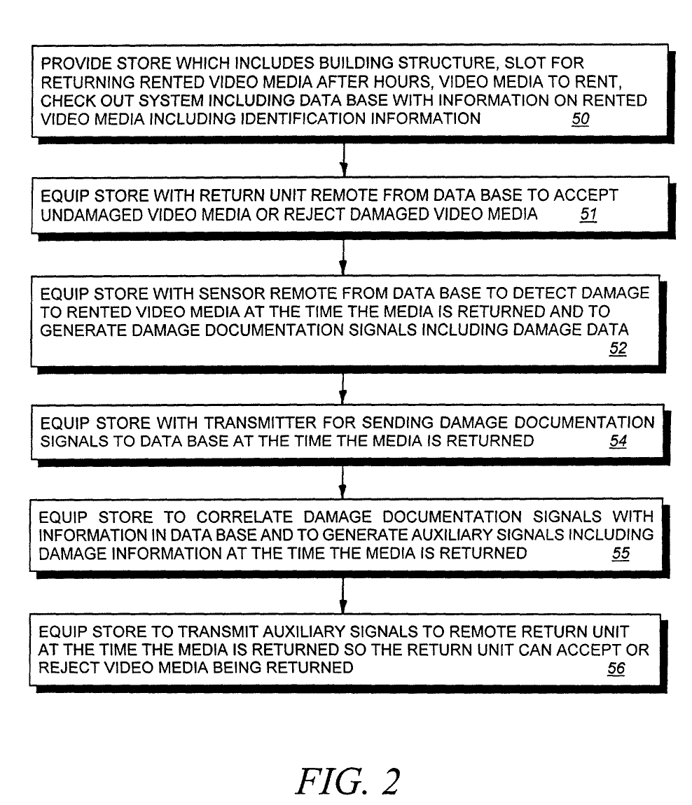

FIG. 2 is a block flow diagram illustrating the method of retrofitting a video rental retail establishment in accordance with the principles of the invention;

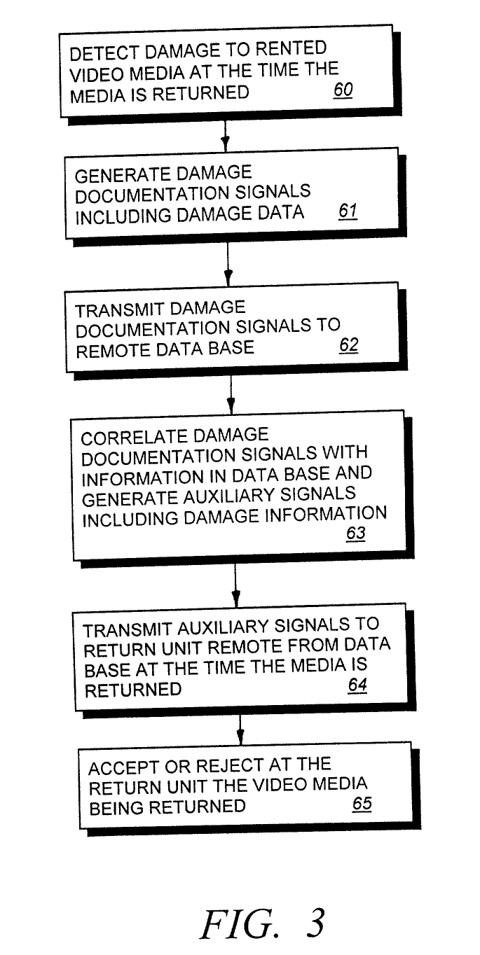

FIG. 3 is a block flow diagram illustrating a method for detecting damage to a rented video media at the time the media is returned after hours;

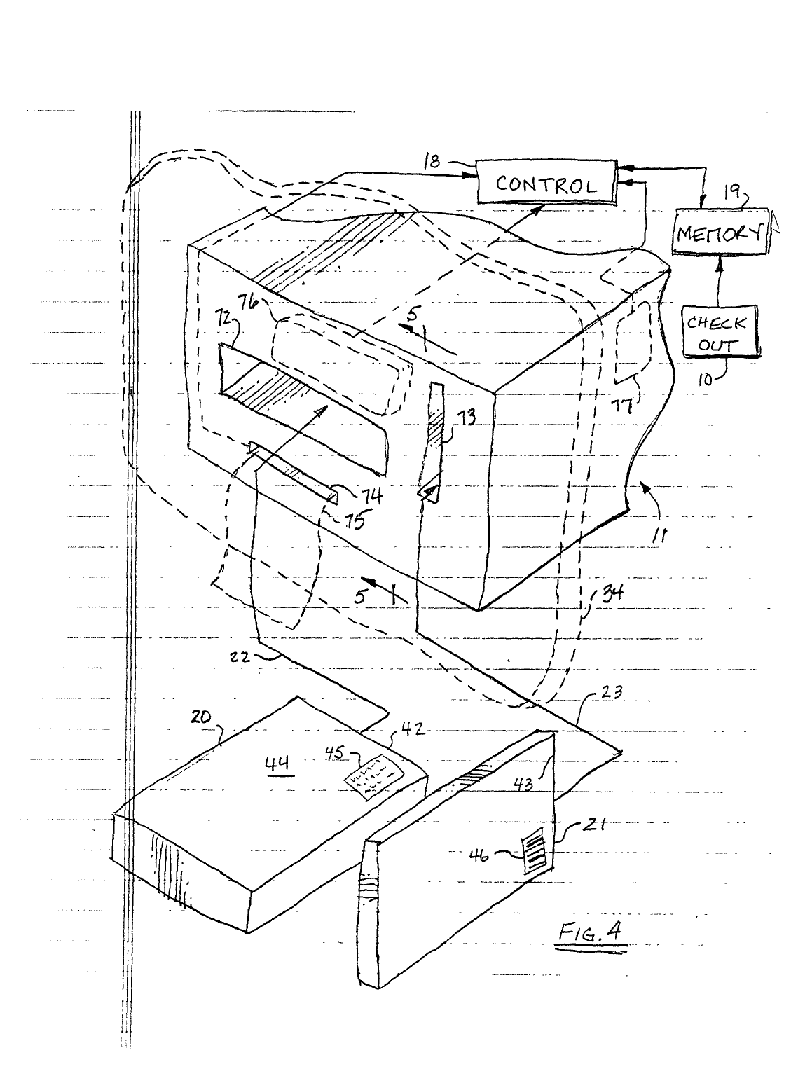

FIG. 4 is a perspective view illustrating apparatus for renting and returning video media in accordance with the principles of the invention; and,

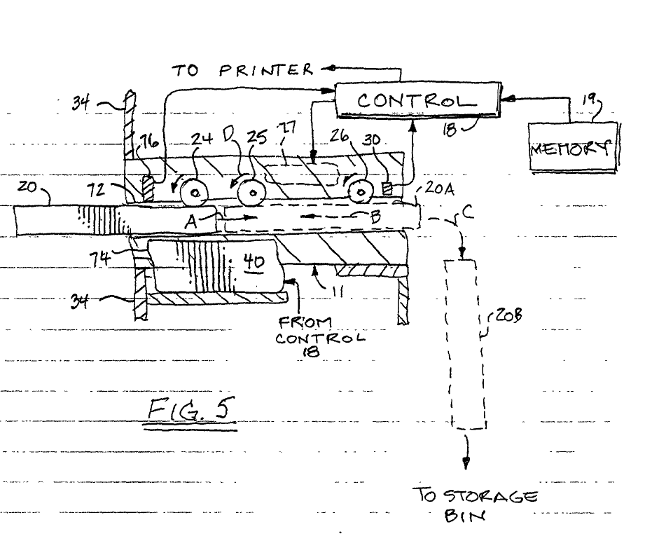

FIG.5 is a side section view of the apparatus of FIG. 4 taken along section line 5-5 and illustrating further construction details thereof.

Briefly, in accordance with the invention, I provide improvements for a retail establishment for renting video media. The retail establishment includes a building structure; a check out area in the building structure; a data base including identification information for video media which has been rented; and, a return site for a customer to return video media when the store is closed for business. The improvements comprise an improved method for adapting the retail establishment to determine at the time rented video media are being returned at the return site if there is damage to the rented video media,. The improved method includes the steps of installing remote from the data base return apparatus for accepting undamaged video media being returned and for rejecting damaged video media being returned; installing remote from the data base sensor means for detecting damage to rented video media being returned and for generating damage documentation signals; installing transmission means in the retail establishment to transmit the damage documentation signals to the data base; installing in the retail establishment means for correlating the damage documentation signals with information in the data base, and for generating auxiliary signals including damage information; and, installing in the retail establishment means for transmitting the auxiliary signals to the return apparatus so the return apparatus can accept or reject the video media being returned.

In another embodiment of the invention, I provide an improved method of returning rented video media to a retail establishment which rents video media. The retail establishment includes a building structure; a check out area in the building structure; a data base including identification information for video media which has been rented; and, a return site remote from the data base for a customer to return video media when the store is closed for business. The improved method includes the steps of detecting at the return site damage to a rented video media at the time the media is returned to the return site, generating damage documentation signals at a location remote from the data base; transmitting the damage documentation signals to the data base; correlating the damage documentation signals with information in the data base and generating auxiliary signals including damage information; and, transmitting the auxiliary signals to the return site at the time the rented video means is being returned.

Turning now to the drawings, which illustrate the presently preferred embodiments of the invention for the purpose of illustrating the practice thereof, and not by way of limitation of the scope of the invention, and in which like reference characters refer to corresponding elements throughout the several views, FIG. 1 illustrates a retail establishment for renting and returning video media. As used herein, the term video media includes a tape for a VCR, includes the tape for a VCR in combination with the case in which the tape is normally sold and stored in, includes a DVD, includes a DVD in combination with the case in which the DVD is normally sold and stored in, and includes any other video data storage unit—alone or in combination with the case in which the unit is normally stored—which can be used to produce a video image on a television screen, CRT screen, or any other display. A video image is an electronically produced visual image. By way of example, and not limitation, the images produced by a VCR tape on a television screen are video images. The images produced by a DVD movie on a television screen are video images. The images produced by a PLAY STATION 2 game disk on a television screen are video images.

The retail establishment of FIG. 1 includes features commonly found in conventional retail establishments for renting video media. Consequently, the retail establishment shown in FIG. 1 includes a building structure 16 provided with walls 31, 32, 33, 34. The store is accessed through doors 36. Tables 37, shelves, or other furniture units are provided for storing and displaying for rent video media 35. A customer selects video media for rental and pays the rental charges at check out 10. A cash register is typically included at check out 10, along with a memory 19 which maintains a computer data base of the various video media which have been check out. Memory 19 can include the bar code or other identification data on or in the video media, can include the date the video media is checked out, the return date by which the video media must be returned, the name of the customer, the address of the customer, the telephone number of the customer, and/or the customer's credit card number, etc. After paying the rental charges at the check out 10, the customer exits the store through doors 36. When the customer later returns the rented video media, the customer can, if the store is open for business enter the store and return the video media at check out 10 or at another designated location. If the customer visits the store and the store is not open because it closed earlier in the day, because it is a holiday, etc., then the customer can return the rented video media through slot 15 and into bin 14. The store may also allow the customer to return the rented video media through slot 15 when the store is open for business.

Slot 15 can be accessed by a customer from a sidewalk that is outside the store and adjacent wall 34. As a result, a customer can readily return rented video media through slot 15 at any time day or night. Slot 15 is typically sized to receive VCR cases or DVD cases. As noted, the foregoing features of retail establishment 16 are commonly encountered. However, conventional video rental retail establishments apparently have no means for determining if rented video media is, at the time it is returned to the retail establishment, damaged.

In the embodiment of the invention illustrated in FIG. 2, in step 51 a return unit 11 is mounted on wall 34 remote from the data base in memory 19. In step 52, a sensor is mounted on wall 34 remote from the data base in memory 19 to detect damage to rented video media at the time the media is returned and to generate damage documentation signals including damage data. In step 53, a transmitter is provided to send the damage documentation signals to the data base in memory 19 at the time the video media is returned. In FIG. 1 the transmitter is provided in control 18 and sends electrical signals via line 12. The signals can also be sent via the air (“wireless”) as radio signals, microwaves, or light, be sent by fiber optic line, etc. In step 54, the damage documentation signals are correlated with information in the data base in memory 19 and auxiliary signals are generated. The auxiliary signals include damage information at the time the media is being returned. The correlation of the damage documentation signals with information in the data base is carried out by control 18, by a computer associated with memory 19, or by any other desired means. During this correlation, damage is found to occur if the rented video media being returned does not meet one or more selected criteria. For example, a rented video media can be determined to be damaged and non-returnable (or to be returnable with a fine) if the case for storing a VCR, DVD, etc. is damaged, if the bar code or other identification information on the case can not be read, if the case for storing a VCR, DVD etc. is empty, if the VCR tape is damaged (for example, if part of the tape is gone), if the bar code or other identification information on the rented video media does not correlate to any tape identified in the data base, and/or if the rented video media is being returned late, etc. In the event unit 11 or control 18 is equipped with memory 19 and a database therein, such a data base is still considered remote simply because the information stored in the database is entered at a remote location, i.e. at a check out 10 which is separate from return unit 11. In step 55, the auxiliary signals are transmitted to the remote unit 11 so unit 11 can accept or reject the rented video media being returned.

When unit 11 accepts the video media it directs the video media into bin 14. When unit 11 rejects the video media it returns it to the customer. In either case unit 11 may, if desired, print a receipt identifying (if possible) the rented video media being returned and the date the return is made or attempted. For example, if damage to the storage case or the a VCR tape or DVD disk is detected by a particular sensor, the unit 11 can reject the video media and display on a screen (not shown) or on a receipt printed to the customer “VIDEO MEDIA DAMAGED. RETURN TO COUNTER WHEN WE ARE OPEN FOR BUSINESS”. Or, if the identification on the video media does not correspond to any video media found in the data base in memory 19, unit 11 can reject the video media and print or display the message “VIDEO MEDIA DAMAGED AND NOT RETURNABLE. IT DOES NOT CORRESPOND TO ANY RECORD IN OUR DATABASE. PLEASE TAKE TO COUNTER WHEN WE ARE OPEN FOR BUSINESS.” Or, if the rented video media is being returned late, unit 11 can accept the video media and display or print the message “YOU ARE LATE. WE ARE ACCEPTING YOUR VIDEO BUT THERE IS A FINE DUE.” Unit 11 can then print a customer receipt detailing the fine due, date rented, date due, name of customer, name of video media, etc.

In the method of the invention illustrated in FIG. 3, step 60 is the first step taken during the return of rented video media. In step 60, at the time the rented video media is returned, damage to the media is detected. In step 61, damage documentation signals are generated, including damage data. In step 62, the damage documentation signals are transmitted to a remote data base. In step 63, the damage documentation signals are correlated with information in the remote data base and auxiliary signals are generated. The auxiliary signals include damage information. In step 64, the auxiliary signals are transmitted to the return unit remote from the data base at the time the media is returned. Finally, in step 65 the video media which is being returned is accepted or rejected at the return unit.

FIG. 4 illustrates a return unit 11 which can be utilized in the practice of the invention. Unit 11 is mounted in an outer or perimeter wall 34 of a retail establishment (FIG. 1) store that rents VCR movies, DVD movies, and other video media. The retail establishment can rent video media at normal rental prices, at higher-than-customary prices, or at discount prices.

A first reception site is formed in unit 11 and comprises a horizontally oriented slot 72 sized to receive a VCR case 20 (normally with a VCR tape in the case) in the manner indicated by arrow 22. A second reception site is formed in structure 11 and comprises a vertically oriented slot 73 sized to receive a DVD case 21 (normally with a DVD in the case) in the manner indicated by arrow 23. Slots 72 and 73 are accessible by a customer from outside the retail establishment of FIG. 1, as is slot 15.

Sensor 76 is mounted in structure 11 and detects when the leading edge 42 of a VCR case is slid into slot 72. A similar sensor (not shown) is mounted in structure 11 and detects when the leading edge 43 of a DVD case is slid into slot 73. A printer 40 (FIG. 2) is mounted in structure 11 and prints and dispenses to a customer a receipt 75 or other information outwardly through slot 74.

When sensor 76 detects the leading edge 42 of a VCR case entering slot 72, sensor 76 generates a signal and transmits the signal to control 18. Control 18 sends a signal to and activates motor 27. Motor 27 runs for a selected period of time and rotates rollers 24 to 26 in the direction of arrow D. Rollers 24 to 26 contact the top 44 of case 20 and displace case 20 in the direction of arrow A to the position indicated by dashed lines 20A (FIG. 5).

While case 20 is displaced in the direction of arrow to the position indicated by dashed lines 20A, sensor 76 scans the case to determine if the case is the proper shape and dimension (i.e., to determine if the case has been broken, dented, or otherwise damaged), to determine if a VCR tape is in the case, and to determine if the quantity of tape reeled on the VCR tape is correct (i.e., to determine if part of the tape has been removed from the case). The sensor 76 generates damage documentation signals and transmits them to control 18 and/or to the data base in memory 19. Auxiliary signals are generated by control 18 and/or memory 19. If the VCR tape is damaged, these auxiliary signals instruct unit 11 to reject the tape which is being returned. One way that unit 11 can reject the tape is for control 18 to transmit a signal to motor 27. Motor 27 causes rollers 24 to 26 to turn in a direction opposite that of arrow D so that VCR case 20A is displaced in the direction of arrow B out of slot 72 back into the hand of the customer who is attempting to return the VCR case. When case 20A is moved in the direction of arrow B out of slot 72, control 18 can direct printer 40 to produce a receipt that states “VIDEO MEDIA DAMAGED. RETURN TO COUNTER WHEN WE ARE OPEN FOR BUSINESS”. The fact that the VCR case 20 is damaged, and the manner in which it is damaged, is recorded in the memory in control 18 and/or in the data base in memory 19, along with the date that return of the VCR case 20 is attempted. When case 20 is damaged, control 18 and/or the data base in memory 19 can also accept the case 20 by directing motor 27 to turn rollers in the direction of arrow D to move case 20 from the position indicated by dashed lines 20A to the position indicated by dashed line 20B so that case 20 falls into storage bin 14. At the same time, control 18 and/or the data base causes a message to be displayed on a screen to the customer or to be printed on a receipt to a customer: “YOUR VIDEO MEDIA IS DAMAGED. THERE WILL BE A CHARGE TO YOUR ACCOUNT. PLEASE CALL US IF YOU HAVE QUESTIONS. DATE OF RETURN: Jun. 15, 2001. DATE OF RENTAL: Jun. 12, 2001. CUSTOMER NAME: WILLIAM CUNNINGHAM. VIDEO MEDIA: VCR. VIDEO NAME: SOUND OF MUSIC. SERIAL NO.: 276344.”

After case 20 is in the position indicated by dashed lines 20A, control 18 activates sensor 30. Sensor 30 reads the bar code or other identification data 45 on or in case 20, generates damage documentation signals including the data, and transmits the signals to control 18. Control 18 queries memory 19 to determine whether a VCR case with the identification data 45 on or in case 20 was rented and checked out from the store. If there is no record in memory 19 of a tape with identification data 45 being previously checked out of the store, control 18 generates and transmits an auxiliary signal to motor 27 to reject case 20. Motor 27 causes rollers 24 to 26 to turn in a direction opposite that of arrow D so that VCR case 20A is displaced in the direction of arrow B out of slot 72. The customer withdraws the case 20 outwardly away from slot 72 and attempts to return case 20 to the store using another mechanism, or, the customer returns case 20 to another store. Control 18 directs printer 74 to print a receipt 75 that reads “VIDEO MEDIA IS DAMAGED AND IS NOT RETURNABLE. VIDEO MEDIA DOES NOT CORRESPOND TO ANY RECORD IN OUR DATABASE. PLEASE TAKE TO COUNTER WHEN WE ARE OPEN FOR BUSINESS.”

If, on the other hand, there is in memory 19 a record that a VCR case with the identification data 45 was checked out, then control 18 generates and sends an auxiliary signal to motor 27 to accept case 20. Motor 27 runs for a selected period of time to rotate rollers 25 and 26 and to displace VCR case 20 in the direction of arrow C such that it travels out of slot 72 and falls in the manner indicated by arrow C and dashed lines 20B into a storage bin located either in the store or at some other desired location.

The identification data 45 can be the name of the movie in the case 20, can be a serial number that identifies the case, or can be any other desired information that identifies case, and, preferably, identifies the case separately from any other video media rented by the store. The identification data 45 can be at any desired location on or in case 20. For example, the identification data can be stored in a microchip which is on or in case 20 or on or in the VCR tape stored in the cased, which microchip can be read by sensor 30.

In the event that an undamaged VCR case 20 is accepted by control 18 and/or the data base in memory 19, the case 20 is dispensed by control 18 in the direction of arrow C into a storage bin 14. Control 18, if desired, sends signals to printer 40. Printer 40 imprints a receipt 75 and dispenses the receipt 75 outwardly through slot 74. Data identifying the case 20 dispensed into the storage bin is imprinted on receipt 75, along with the date that case 20 was returned by inserting case 20 in slot 72. In addition, receipt 75 can also be imprinted with the date case 20 (and the VCR tape in case 20) was originally rented, personal data identifying the customer that rented the tape, and the deadline date for returning case 20 to the store. The deadline date can be represented either by giving the exact date or by indicating on the receipt that the case 20 is due back a certain number of days from the date case 20 is rented. The personal data can include the name of the person, company, etc. that rented the tape, can include that address of the entity that rented the tape, can include the phone number of the entity that rented the tape, can include the address of the entity that rented the tape, and/or can include any other desired information concerning the customer that rented the tape.

Control 18 and/or the data base in memory 19 can wait to receive information from both sensor 76 and sensor 30 before deciding to reject or accept a VCR case 20 or other rented video media that is being returned by a customer.

In FIG. 4, slot 72 completely circumscribes a case 20 inserted therein. The reception site for a video media need not completely circumscribe a case 20, 21. The reception site need only include at least one surface which supports, or contacts, or is adjacent the video media being returned. The surface can be horizontally or vertically oriented or can be positioned in any other desired orientation. For example, the surface can be vertically oriented and a customer can hold a case 20 against or near the surface while a sensor reads identification data on the case. After the identification data 45 is read by a sensor 30 and control 18 and/or the data base in memory 19 indicates that the case 20 bearing the data 45 can be returned, a customer can drop the case 20 into a storage bin slot and receive a receipt. Control 18 and/or the data base in memory 19 can indicate to a customer that the case 20 can be returned by communicating with the customer via an audible message, via a message appearing on a CRT screen or other visible readable display, via a printed message, via a blinking light, or via any other desired means.

The sensor(s) 76 can be any desired sensor and can be placed in any desired position inside or outside of unit 11 as long as sensor 76 can determine when a case 20 (or 21) is pushed into slot 72 (or slot 73) and can detect the particular selected damage or damage(s) to the video media being returned. Similarly, sensor 30 can be any desired sensor and placed in any desired location as long as sensor 30 can read the desired identification data 45 from case 20. As noted, the identification data can be imprinted on case 20, can be on a chip integrated in the case 20, etc.

A single sensor can be utilized to accomplish the functions of sensors 76 and 30. In some embodiments of the invention, sensor 76 is not required. The video media being returned is simply placed adjacent sensor 30. Sensor 77 is comparable to sensor 30, but is used to detect identification data on a DVD which is inserted in slot 73.

In use, a customer rents video media from a retail establishment of the type illustrated in FIG. 1. The media comprises a first VCR case 20 and a second VCR case 20, along with two VCR tapes, each stored in a different one of the cases 20. At check out 10, the store clerk—or a sensor or some other means—enters into a data base in memory 19 for each VCR case 20 the name of the customer, identification data (for example, information from a bar code on or in case 20) for case 20, the address of the customer, the phone number of the customer, the length of time for which the case 20 is rented, the name and address of the retail establishment, and the date by which the case 20 must (along with the VCR tape in the case) be returned. The data base in memory 19 can, if desired, include a controller (microprocessor) and any logic or programs necessary to operate the microprocessor and data base.

The customer returns the first case 20 on the day due. The retail establishment which rented the first case 20 is closed for the night. The customer walks up to the establishment and partially inserts the first case 20 (along with the VCR tape in the first case 20) in slot 72. After receiving a signal from sensor 76, control 18 activates wheels 24 to 26 to move the first case 20 to the position indicated in FIG. 5 by dashed lines 20A. Sensor 30 reads identification data 45 from case 20 and transmits the data in signals to control 18. Control 18 queries the data base in memory 19 to determine if the identification data for the first case is present in memory 19. The identification data is present. There is no other damage detected by sensor 76. Control 18 generates auxiliary signals to motor 27. Motor 27 accepts the first case 20 by activating rollers 25 and 26 to displace the first case 20 out from slot 72 and into the storage bin in the manner indicated by arrow C and dashed lines 20B in FIG. 2. Control 18 directs printer 40 to print and dispense a receipt 75 through slot 74 to the customer. Imprinted on the receipt are (1) the date the first case 20 is returned, (2) the name of the customer that rented the tape, (3) the date the tape was rented, (4) the date by which the tape had to be returned, and (5) identification information identifying first case 20.

The customer returns the second case a day late. The retail establishment which rented the second case 20 is closed for Christmas. The customer walks up to the front of the store and inserts the second case 20 in slot 72. Control 18 activates wheels 24 to 26 to move the second case 20 to the position indicated in FIG. 5 by dashed lines 20A. Sensor 30 reads identification data 45 from case 20 and transmits the data in signals to control 18. Control 18 queries memory 19 to determine if the identification data for the second case 20 is present in memory 19. The identification data 45 is present. Sensor 76 detects that there is no VCR tape in case 20. Control 18 generates auxiliary signals to motor 27. Motor 27 accepts the second case 20 by activating rollers 25 and 26 to displace case 20 out from slot 12 and into the storage bin in the manner indicated by arrow C and dashed lines 20B in FIG. 2. Control 18 directs printer 40 to print and dispense a receipt 75 through slot 74 to the customer. The receipt states: “YOUR VIDEO MEDIA IS DAMAGED. A TAPE IS NOT IN THE CASE. THE TAPE IS LATE. THERE WILL BE ADDITIONAL CHARGES. PLEASE CALL US IF YOUR HAVE QUESTIONS. DATE RENTED: Jun. 23, 2001. DATE RETURNED: Jun. 25, 2001. DATE DUE BACK: Jun. 24, 2001. IDENTIFICATION: SERIAL NO. 16598323. NAME: SOUTH PACIFIC. MEDIA: VCR. CUSTOMER: WILLIAM CUNNINGHAM. STORE: BLOCKBUSTER NO. 201, PHOENIX, LATE FEE: ONE DAY @ $3.00. OTHER DAMAGE CHARGES: REPLACEMENT @ $20.00.” In addition or in place of receipt 15, control 18 can also have an electronic receipt prepared which is sent to the customer or, if desired, to the store. The electronic receipt can be sent by e-mail to the customer, can be sent to a customer's designated bank account or other account, can be printed out at another location and mailed to the customer, etc.

Having described the invention in such terms as to enable those of skilled in the art to understand and practice the invention, and having described the presently preferred embodiments thereof I claim:

1. In combination with a retail establishment for renting video media, the retail establishment including
a building structure,
a check out area in the building structure,
a data base including identification information for video media which has been rented, and
a return site for a customer to return video media when the retail establishment is closed for business, the improvements comprising a method for adapting the retail establishment to determine at the time rented video media are being returned at the return site if there is damage to the rented video media, the method including the steps of
(a) installing remote from the data base return apparatus for accepting undamaged video media being returned and for rejecting damaged video media being returned;
(b) installing remote from the data base sensor means for detecting damage to rented video media being returned and for generating damage documentation signals;
(c) installing transmission means in the store to transmit the damage documentation signals to the data base;
(d) installing in the store means for
(i) correlating the damage documentation signals with information in the data base, and
(ii) generating auxiliary signals including damage information;
(e) installing in the retail establishment means for transmitting the auxiliary signals to the return apparatus so the return apparatus can accept or reject the video media being returned.

2. A method of returning rented video media to a retail establishment which rents video media, the store including
a building structure,
a check out area in the building structure,
a data base including identification information for video media which has been rented, and
a return site for a customer to return video media when the retail establishment is closed for business, the method including the steps of
(a) detecting at the return site damage to a rented video media at the time the media is returned to the return site;
(b) generating damage documentation signals at a location remote from the data base;
(c) transmitting the damage documentation signals to the data base;
(d) correlating the damage documentation signals with information in the data base and generating auxiliary signals including damage information;
(e) transmitting the auxiliary signals to the return site at the time the rented video means is being returned.
